(19) United States
(12) Patent Application Publication
(10) Pub. No.: US 2005/0010720 A1
(43) Pub. Date: Jan. 13, 2005

(54) Content addressable memory device capable of weight search

(75) Inventor: Yoshihiro Ishida, Mihama-ku (JP)

Correspondence Address: OLIFF & BERRIDGE, PLC, P.O. BOX 19928, ALEXANDRIA, VA, 22320, US

(73) Assignee: KAWASAKI MICROELECTRONICS, INC., Mihama-ku (JP)

(21) Appl. No.: 10/844,416

(22) Filed: May 13, 2004

(30) Foreign Application Priority Data
May 15, 2003 (JP) 2003-137524

(51) Int. Cl. G06F 12/00; G06F 13/00

(52) U.S. Cl. 711/108

(57) ABSTRACT

A content addressable memory device includes a CAM core having a plurality of words. Each word includes a data field for storing target data and a weight field for storing weight data for use in weighting the target data stored in the data field. Both the data field and the weight field are simultaneously searched, for matching between search key data and the target data stored in the data field and for matching between weight search data used for searching for the weight data and the weight data stored in the weight field, and a search result is output from among the words storing the target data that is matched with the search key data in accordance with the weight of the target data.

### BACKGROUND OF THE INVENTION

1. Field of the Invention

The present invention relates to a content addressable memory (hereinafter referred to as a CAM) device for outputting a search result in accordance with a weight of target data from among words storing target data that is matched with search key data.

2. Description of the Related Art

Since a CAM device using ternary cells, which store any of ‘0’, ‘1’, or ‘X’ (don't care) as one bit, can set an arbitrary bit in a word to ‘X’, it is highly likely that a plurality of words is matched with search key data. If a plurality of words is matched with search key data, the address of a word, for example, having the smallest address, among the plurality of words that stores the matched data is output in accordance with a predetermined priority as a search result.

Well-known search methods in which a plurality of words produces a match because ‘X’ is set as data include a longest prefix match (LPM) used for searching for an internet protocol (IP) address.

In the LPM, data having the network address that is longest matched from the most significant bit with search key data is detected.

IP address is 32-bit data, like 192.168.0.0/16 (decimal notation), an IP address is delimited by periods and every eight bits are represented decimally. An IP address is divided into a network address toward upper bits and a host address toward lower bits. The delimiter between the network address and the host address is a numeric value ‘16’ following ‘/’. In this case, the length of the network address from the most significant bit (prefix length) is 16 bits.

In order to realize the LPM by using a CAM, the bits corresponding to the network address in IP address, are stored without change in each word in the CAM, and the bits corresponding to the host address are stored as ‘X’. Since the data having a longer prefix length has a higher priority in the LPM, the data is ordinarily sorted in descending order of the prefix length and is stored in the CAM in ascending order of the address for conducting a search. A word having the smallest address among a plurality of matched words is output as the search result.

Accordingly, it is possible to output a longest matched word with the search key data, which has the smallest address, that is, a word having the highest priority, as the search result with a single search.

However, according to this method, it is necessary to sort the data in descending order of the prefix length each time new data is registered or unnecessary data is deleted, thus disadvantageously deteriorating the search throughput.

An LPM searching device in which entry data is not required to be re-sorted is disclosed in Japanese Patent Application Publication No. 11-284658. This LPM searching device stores, in each word of its CAM, a pair of a 32-bit IP address and 5-bit prefix data representing the prefix length in binary form. When search key data is input, the bits of the IP address are sequentially masked from the least significant bit and the prefix data for search is sequentially prepared from 31 to 0 in decimal notation in order to simultaneously search the 37-bit entry data. However, with this method, there is a problem in that it is necessary to perform the search up to maximum 32 times to detect the longest matched entry data.

A method of searching for the longest matched data by using a CAM is disclosed in Japanese Patent Application Publication No. 2003-244208.

In this publication, a 32-bit IP address and a 32-bit flag series are stored as entry data. The p bits from the most significant bit in the flag series, representing the prefix length p of the IP address, are stored as ‘1’ and the remaining bits are stored as ‘0’. The flag series, which is divided into two pieces, is searched six times for one target IP address to detect entry data having the longest prefix length.

However, this method is inefficient because the flag series represent only n kinds of prefix lengths with N bits. In addition, the memory space cannot be effectively utilized because the IP address can occupy only half of one word. For example, when one word has a length of 64 bits, the data occupies 32 bits and the flag series occupies 32 bits. Furthermore, a plurality of devices cascaded to each other for usage is not mentioned in this publication.

### SUMMARY OF THE INVENTION

Accordingly, it is an object of the present invention to provide a CAM device capable of reducing the number of times a search is performed and of improving the throughput even if a plurality of words which include target data produces a match. It is another object of the present invention to provide a CAM device capable of effectively utilizing the memory space. It is another object of the present invention to provide a CAM device having applications other than the LPM of an IP address.

The present invention provides, in its first aspect, a content addressable memory device including a CAM core having a plurality of words, each word includes a data field for storing target data and a weight field for storing weight data for use in weighting the target data stored in the data field. Both the data field and the weight field are simultaneously searched for matching between search key data and the target data stored in the data field and for matching between weight search data and the weight data stored in the weight field, and a search result is output from among the words storing the target data that is matched with the search key data in accordance with the weight of the target data. The weight search data is automatically generated in the content addressable memory device, from the most significant bit to lower bits in accordance with search result of the data field.

It is preferable that the weight of the target data is binary encoded in the weight data.

Here, each word is preferably formed of a ternary cell that stores any of three values. Particularly, the data field is preferably formed of the ternary cell.

The present invention provides, in its second aspect, a content addressable memory device including a CAM core having a plurality of words, each word including a data field for storing target data and a weight field for storing weight data for use in weighting the target data stored in the data field; and a weight search controller for controlling the CAM core such that the CAM core repeats the search by the number of times corresponding to the bit width of the weight field to generate the weight search data having the same value as the most heavy weight data or the least heavy weight data.

It is preferable that the CAM device further includes a weight key data/mask data generator for generating weight key data and mask data indicating whether a corresponding bit in the weight key data is masked or not for each bit. The weight key data/mask data generator generates weight key data such that, in the first search, all the bits in weight key data has the same value, and as the result of the i-th (1≦i≦a number corresponding the bit width of the weight field) search, the value of the i-th bit in the next search is kept if a hit is detected and the value of the i-th bit is inverted if a hit is not detected. The weight key data/mask data generator generates mask data such that, in the i-th search, the mask data indicates that i bits from the most significant bit in the weight key data are not masked and the remaining bits are masked. And the CAM core are searched by using the search key data and the weight search data which is generated by the weight key data and the mask data.

It is preferable that the weight search controller controls the CAM core such that the CAM core executes the final search by using the generated weight key data and the mask data indicating that no bits in the weight key data are masked.

It is preferable that the CAM device further includes a register for setting the bit width of the weight field, and that the bit width of the weight field be varied in accordance with the bit width set by the register.

It is preferable that the CAM device further includes a cascade signal input circuit and a cascade signal output circuit used for control when a plurality of CAM devices is cascaded to each other for usage. It is also preferable that, when the plurality of devices is cascaded for usage, the cascade signal output circuit output cascade signals to all the upper-level and lower-level CAM devices, and that cascade signals output from all the upper-level and lower-level CAM devices be supplied to the cascade signal input circuit, and that the cascade signals input from the cascade signal input circuit be supplied to the weight search controller. It is further preferable that the weight search controller control the CAM core such that the CAM core outputs a search result in accordance with the weight of the target data if a plurality of CAM devices produces a hit.

According to the present invention, since the CAM device weighs the target data, it is possible to output the search result in accordance with the weight of the data even if a plurality of words include target data produces a match. There is no need to sort the data, unlike a known CAM device, thus performing the search process at high throughput.

Since the CAM device according to the present invention stores the binary encoded weight data, it is possible to represent the n-th power of two different weights with N bits, thus effectively utilizing the bits. In addition, the bit width of the weight field is variable, so that the bit widths of the data field and the weight field can be adjusted if required, thus effectively utilizing the memory capacity. Furthermore, the number of times a search is performed can be reduced in accordance with the bit width of the weight field and it is possible to use a plurality of devices cascaded to each other.

### BRIEF DESCRIPTION OF THE DRAWINGS

FIG. 1 is a diagram schematically showing the structure of a CAM device according to an embodiment of the present invention;

FIGS. 2A and 2B are diagrams schematically showing the structure of a word according to an embodiment of the present invention;

FIG. 3 is a conceptual diagram illustrating weight search operation according to an embodiment of the present invention;

FIG. 4 is a diagram schematically showing a state where CAM devices of the present invention cascaded to each other according to an embodiment; and

FIG. 5 is a conceptual diagram showing each state in a weight search operation according to an embodiment when a plurality of CAM devices is cascaded to each other.

### DETAILED DESCRIPTION OF THE PREFERRED EMBODIMENTS

A content addressable memory (CAM) device of the present invention will be described in detail below based on preferred embodiments with reference to the attached drawings.

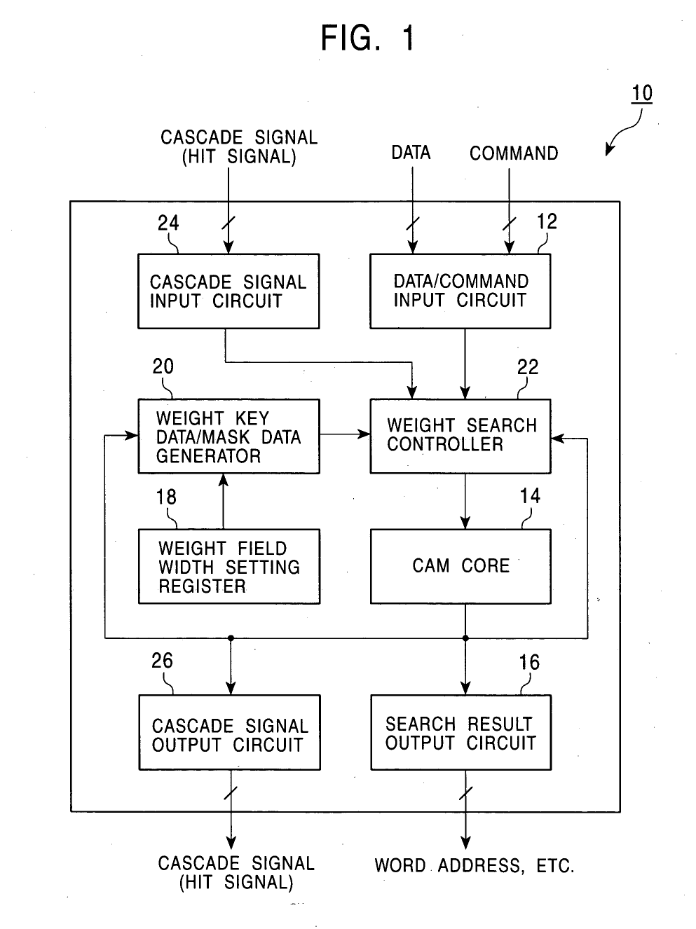

FIG. 1 is a diagram schematically showing the structure of a CAM device according to an embodiment of the present invention. A CAM device 10 includes a data/command input circuit 12, a CAM core 14, a search result output circuit 16, a weight field width setting register 18, a weight key data/mask data generator 20 (hereinafter referred to as the WM generator 20), a weight search controller 22, a cascade signal input circuit 24, and a cascade signal output circuit 26.

Input data, such as entry data or search key data, and commands, such as a writing command or a search command, are supplied to the CAM device 10 through the data/command input circuit 12 and are stored in the CAM core 14.

The CAM core 14 has a plurality of words (not shown) formed of ternary CAM cells. Each ternary CAM cell can store data having any of three values (‘0’, ‘1’, or ‘X’). The CAM core 14 is further provided with an address decoder, a priority encoder, or the like, which an ordinary CAM is provided with.

One word is divided into a data field for storing target data and a weight field for storing weight data for use in weighting the data stored in the data field. An attribute of the data stored in the data field (for example, the prefix length of an IP address stored in the data field) is binary encoded and stored as the weight data. The bit width of the weight field is variable and is set by the weight field width setting register 18. The bit width of the data field can also be varied in accordance with the bit width of the weight field.

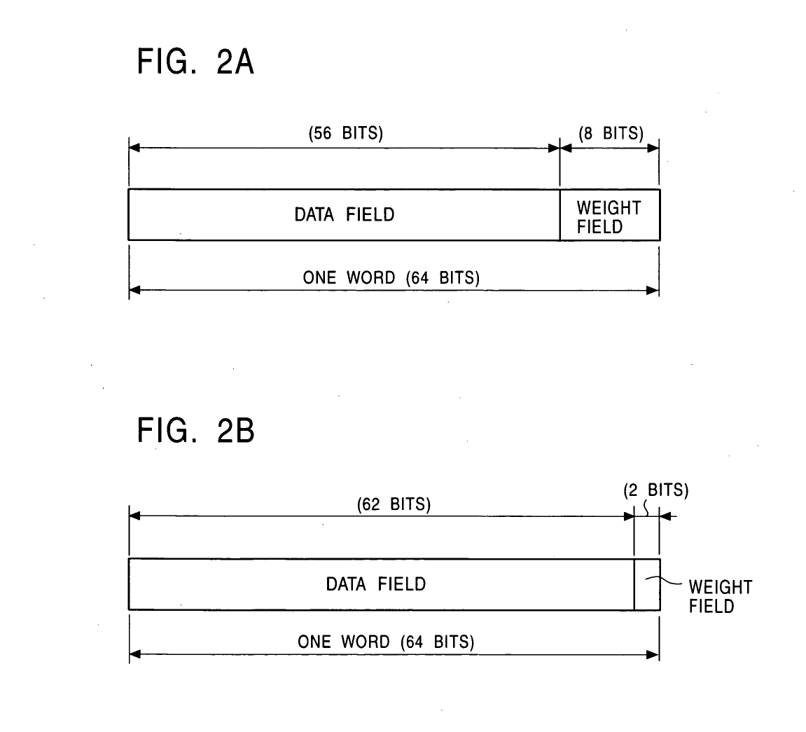

FIGS. 2A and 2B are diagrams schematically showing the structure of a word having a width of 64 bits. Referring to FIG. 2A, when the weight field has a width of eight bits, the data field has a width of 56 bits. In this case, the data in the data field can be weighted in 256 levels. Referring to FIG. 2B, when the weight field has a width of two bits, the data field has a width of 62 bits. In this case, the data in the data field can be weighted in four levels.

When the search key data and the search command is supplied through the data/command input circuit 12, the CAM core 14 searches all the words for matching between the search key data and the data stored in the data field and for matching between weight key data and the weight data stored in the weight field under the control of the weight search controller 22. The CAM core 14 outputs a hit signal indicating whether there are any matched words or not each time a search is performed, and outputs a search result (the address of a word storing most heavily weighted data) from among the words storing the data that is matched with the search key data in accordance with the weight of the data each a search key data. Here, “hit” in the hit signal means that there is at least one matched word, and “no hit” means that there are none of matched words.

The search result (including the hit signal) output from the CAM core 14 is externally output from the CAM device 10 through the search result output circuit 16. The hit signal output from the CAM core 14 is fed back to the weight search controller 22 and is also supplied to the WM generator 20 and the cascade signal output circuit 26.

As described above, the weight field width setting register 18 sets the bit width of the weight field. The bit width output from the register 18 is supplied to the WM generator 20.

The WM generator 20 automatically generates the weight key data for use in searching for the weight data and mask data indicating whether or not a corresponding bit in the weight key data is masked for each bit. The weight key data and the mask data generated by the WM generator 20 are supplied to the weight search controller 22.

The weight search controller 22, in this embodiment, controls the CAM core 14 such that the CAM core 14 searches the most heavily weighted data by using the weight key data and the mask data generated by the WM generator 20.

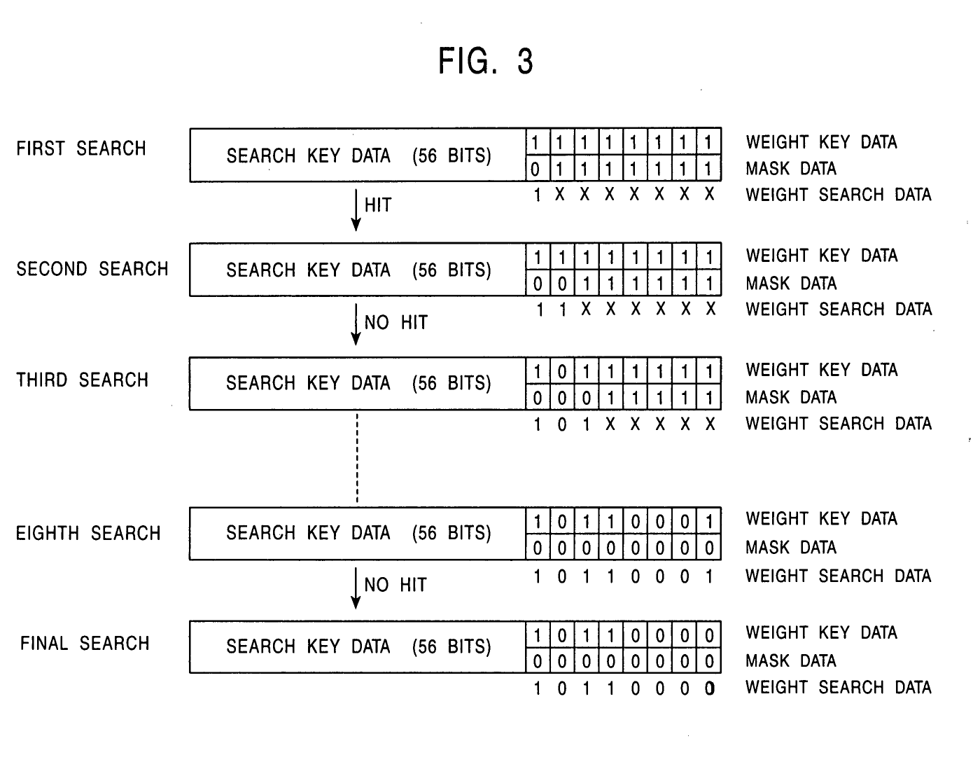

FIG. 3 is a conceptual diagram illustrating the weight search operation. The data field of each word in the CAM core 14 stores the target data. The weight field of each word in the CAM core 14 stores the weight data of the data stored in the data field.

Referring to FIG. 3, in the first search, the weight key data ‘11111111’ and the mask data ‘01111111’ are generated by the WM generator 20. Bit ‘0’ in the mask data indicates that a corresponding bit in the weight key data is not masked and ‘1’ therein indicates that the bit is masked. The CAM core 14 performs the first search by using the search key data, the weight key data, and the mask data under the control of the weight search controller 22.

In other words, all the words are searched for matching between the search key data and the data stored in the data field. Also, based on the mask data ‘01111111’, all the words are searched for matching between weight search data ‘1XXXXXXX’ in which all but the most significant bit in the weight key data are masked and the weight data stored in the weight field. Namely, only the most significant bit in the weight data is searched for matching.

As a result, when the words storing the data that is matched with the search key data include a word having ‘1’ in the most significant bit of the weight data, a hit signal is output as the search result. In this case, the WM generator 20 generates the weight key data ‘11111111’, in which ‘1’ is kept in the most significant bit, as the weight key data used in the subsequent (second) search.

In contrast, when a word having ‘1’ in the most significant bit of the weight data does not exist, “no hit” is output as the hit signal. In this case, the WM generator 20 generates the weight key data ‘01111111’ having ‘0’ in the most significant bit as the weight key data used in the subsequent (second) search. According to this embodiment, it is assumed that the hit signal is output at the first search.

In the second search, the weight key data ‘1111111’ and the mask data ‘00111111’ are generated. Namely, only the top two significant bits in the weight data is searched for matching.

As a result of the second search, when the words storing the data that is matched with the search key data include a word having ‘1’ in the second significant bit of the weight data, a hit signal is output as the search result. In contrast, when a word having ‘1’ in the second significant bit of the weight data does not exist, “no hit” is output as the hit signal.

According to this embodiment, it is assumed that “no hit” is output at the second search. In the third search, the weight key data ‘10111111’ having ‘0’ in the second significant bit of the weight key data and the mask data ‘00011111’ are generated.

As the result of the i-th (1≦i≦8) search, the i-th significant bit in the weight key data in the subsequent search is ‘1’ if “hit” is output and is ‘0’ if “no hit” is output. The mask data has ‘0’ in the top i bits and ‘1’ in the remaining (8-i) bits in the i-th search. Namely, ‘0’ is sequentially embedded from the most significant bit in the mask data.

As shown in FIG. 3, according to this embodiment, the search is performed eight times for one search key data, corresponding to the bit width of the weight field. As the result of the eighth search, the weight key data ‘1011000’ having the same value as the most heavy weight data is obtained.

Accordingly, performing the final search (the ninth search in this embodiment) by using the search key data, the weight key data obtained as the result of the eighth search, and the mask data ‘00000000’ (bits in the weight key data are not masked) can detect the word storing the most heavily weighted data from among the words storing the data that is matched with the search key data.

Since the CAM device 10 weighs the target data in accordance with its attribute, the CAM device 10 can output the search result in accordance with the weight of the data even when a plurality of pieces of data produces a match. In such a case, it is possible to detect the most heavily weighted data, the most lightly weighted data, or the data having a predetermined weight in accordance with the search process. Furthermore, even when new data is registered or unnecessary data is deleted, there is no need to sort the data, unlike a known CAM device, thus performing the search process at high throughput.

If “hit” is output as the result of the eighth search, both the least significant bit in the eighth weight key data and the least significant bit in the last weight key data are ‘1’ and, therefore, the result of the eighth search is the same as that of the last search. Hence, it may be determined whether or not the last search is performed in accordance with the result of the eighth search.

If a word storing the data that is matched with the search key data does not exist, “no hit” is finally detected as the search result in this embodiment. But, at first search, mask data is made as ‘11111111’ in place of ‘01111111’, then CAM device 10 can detect whether there are at least one word storing the data that is matched with search key data or not, at first search.

In the LPM of an IP address, bits corresponding to the network address are stored as they are in the data field and bits corresponding to the host address are stored as ‘X’ in the data field. The prefix length is binary encoded and stored in the weight field as the weight data. Accordingly, the word having the longest prefix length can be detected from among the words storing the data that is matched with the search key data.

Since IP address is 32 bits and the weight data can be five bits (2⁵=32) in the LPM of an IP address, it is sufficient for one word to have a length of 37 bits. Hence, when one word has a length of 64 bits, the extra 27 bits can be freely used. For example, in addition to the weight data corresponding to the prefix length, other weight data may be stored.

Although it is assumed that all the cells in one word are ternary cells in this embodiment, the cells are not limited to ternary cells. Binary cells each storing either ‘0’ or ‘1’ may be used in one word, or ternary cells may be mixed with binary cells to form one word. Since it is not necessary to store the ‘X’ data in the weight field, the weight field is preferably formed of binary cells each having a small area.

Turning to FIG. 1, the cascade signal input circuit 24 and the cascade signal output circuit 26 in the CAM device 10 are used for control when a plurality of devices is cascaded to each other for usage.

When a plurality of devices is cascaded for usage, cascade signals (the hit signals here) are output from the cascade signal output circuit 26 and are supplied to the cascade signal input circuits 24 in all the upper-level and lower-level devices.

The hit signals from the cascade signal input circuit 24 are supplied to the weight search controller 22.

A case where a plurality of devices is cascaded for usage will now be described.

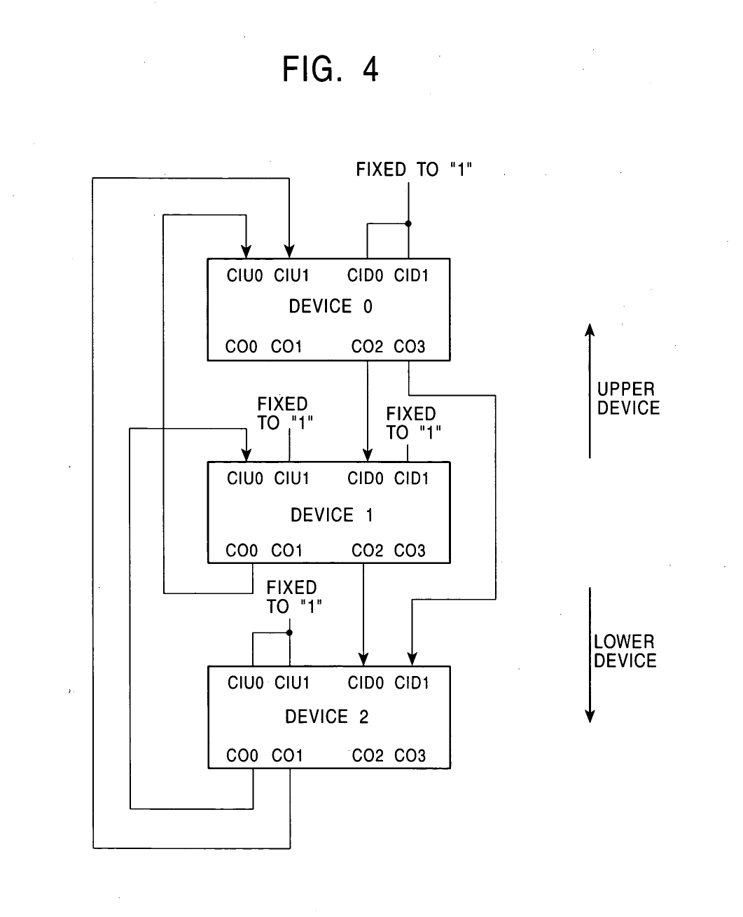

FIG. 4 illustrates three devices 0, 1, and 2 cascaded to each other. With respect to the central device 1, the device 0 is an upper-level device and the device 2 is a lower-level device.

Referring to FIG. 4, reference numerals CO0 to CO3 denote terminals through which the hit signals are output from the cascade signal output circuit 26 in the CAM device 10 shown in FIG. 1. Reference numerals CIU0 and CIU1 denote terminals through which the hit signals output from the lower-level devices are input. Reference numerals CID0 and CID1 denote terminals through which the hit signals output from the upper-level devices are input.

Referring to FIG. 4, ‘1’ in the hit signal represents a state indicating “no hit” and ‘0’ in the hit signal represents a state indicating “hit”. Since the device 0 is the top-level device, the terminals CID0 and CID1 in the device 0 are fixed to ‘1’. The hit signal output from the terminal CO0 in the device 1 downstream of the device 0 is supplied to the terminal CIU0 in the device 0, and the hit signal output from the terminal CO1 in the device 2 is supplied to the terminal CIU1 in the device 0.

The device 0 is located upstream of the device 1 and the device 2 is located downstream of the device 1. Hence, the hit signal output from the terminal CO2 in the device 0 is supplied to the terminal CID0 in the device 1, and the hit signal output from the terminal CO0 in the device 2 is supplied to the terminal CIU0 in the device 1. Since no device other than the device 0 is located upstream of the device 1 and no device other than the device 2 is located downstream of the device 1, the terminals CID1 and CIU1 in the device 1 are fixed to ‘1’.

Since the device 2 is the bottom device, the terminals CIU0 and CIU1 in the device 2 are fixed to ‘1’. The hit signal output from the terminal CO2 in the device 1 upstream of the device 2 is supplied to the terminal CID0 in the device 2, and the hit signal output from the terminal CO3 in the device 0 is supplied to the CID1 in the device 2.

In other words, the hit signals output from all the upper-level devices and the hit signals output from all the lower-level devices are supplied to each device. The terminals CO0 to CO3 can be used interchangeably with each other. For example, the terminal CO0 in the device 1 may be connected to the terminal CIU1 in the device 0, and the terminal CO1 in the device 2 may be connected to the terminal CIU0 in the device 0. The same applies to the terminals CO2 and CO1 and the terminals CID0 and CID1.

The maximum number of devices that can be cascaded for usage is not limited. For example, the maximum number of devices can be varied as the number of the terminals CO, CIU, and CID is increased or decreased. Although, in the above embodiment, a total of four hit signal output terminals, including the two terminals for the upper-level devices and the two terminals for the lower-level devices, are provided in order to cascade the three devices to each other, one terminal may be commonly used. Although a total of four hit signal input terminals, including the two terminals for the upper-level devices and the two terminals for the lower-level devices, are provided, one terminal for the upper-level device and one terminal for the lower-level device may be used. However, in such a case, it is necessary to provide, outside the CAM device 10, a logic gate for the hit signals output from a plurality of upper-level devices and a logic gate for the hit signals output from a plurality of lower-level devices.

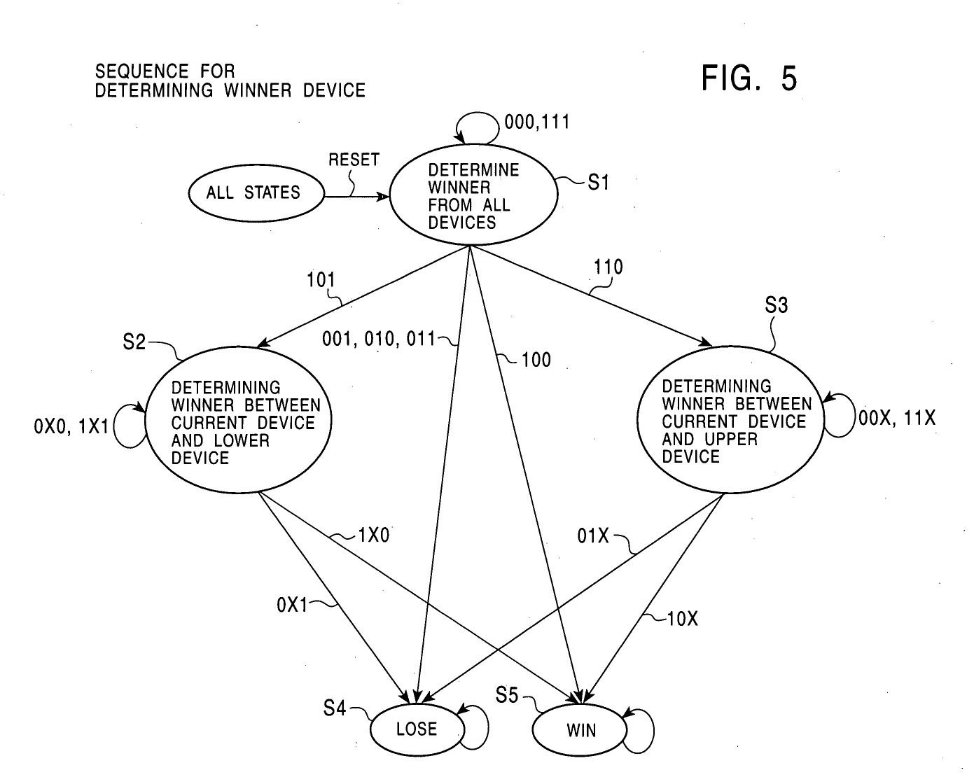

FIG. 5 is a conceptual diagram showing the search operation in the case of using a plurality of devices cascaded to each other.

FIG. 5 illustrates a sequence for determining the winner device that output the search result. When a plurality of devices is cascaded to each other for usage, it is necessary to determine which device finally outputs the search result, that is, a device storing the most heavily weighted data. FIG. 5 illustrates a sequence for determining, based on the search result, the winner from among the current device, all the devices upstream of the current device, and all the devices downstream of the current device, and for finally outputting the search result from the winner device.

As shown in FIG. 5, the sequence is in State S1 immediately after resetting regardless of the state of the current device.

If the triple of hit signals is 10001 or ‘111’ in State S1, the sequence returns to State S1. Referring to FIG. 5, the leftmost bit of ‘000’ or ‘111’ represents the hit signal of the current device, the central bit thereof represents the result of an OR operation for the hit signals output from all the devices upstream of the current device, and the rightmost bit thereof represents the result of an OR operation for the hit signals output from all the devices downstream of the current device. In FIG. 5, ‘0’ represents “no hit” and ‘1’ represents “hit”.

In other words, the triple ‘000’ or ‘111’ that is detected after the first search in State S1 means that there are hits for all the devices or there is no hit for all the devices. Since all the devices have the same condition in this case, hit signals output from all the devices in the subsequent search are the targets of the determination. The search process is repeated toward the lower bits and, if the same search result is repeatedly obtained until the last search, the determination ends in a draw. In this case, the search result having the highest priority, for example, the last search result (the address of a matched word) of the top device, is output as the overall search result.

If the triple is ‘100’ in State S1, the sequence shifts from State S1 to State S5. Since it is determined that the current device is the winner in State S5, the search process is repeated toward the lower bits in the weight field, and the last search result (the address of a matched word) of the current device is output as the overall search result.

If the triple is ‘101’ in State S, the sequence shifts from State S1 to State S2. In State S2, the subsequent determination is performed between the current device and the lower-level device. If the subsequent search result is ‘1X0’, that is, if the current device produces “hit” and the lower device produces “no hit”, the sequence shifts from State S2 to State S5. The search operation in State S5 is performed in the same manner as described above.

If the triple is ‘0X1’ in State S2, that is, if the current device produces “no hit” and the lower device produces “hit”, the sequence shifts from State S2 to State S4. Since it is determined that the current device is the loser in State S4, even if the current device produces “hit” in the subsequent search, the final search result of the current device is not output as the overall search result.

If the search result is ‘0X0’ or ‘1X1’ in State S2, that is, if neither the current device nor the lower device produces “hit” or both the current device and the lower device produce “hit”, the search process is repeated toward the lower bits. If the same search result is repeatedly obtained until the last search, the determination ends in a draw. In this case, the search result having the highest priority, for example, the last search result of an upper device, is output as the overall search result.

If the search result is ‘110’ in State S1, that is, if the both current device and the upper device produce “hit”, the sequence shifts from State S1 to State S3. The search operation in State S3 is the same as in State S2.

If the search result is ‘001’, ‘010’, or ‘011’ in State S1, that is, if the current device produces “no hit” and at least one of the upper and lower device produces “hit”, the sequence shifts from State S1 to S4. The search operation in State S4 is performed in the same manner as described above.

As described above, even when a plurality of devices is cascaded to each other for usage, the search result is output in accordance with the weight of the data if a plurality of devices produces “hit”.

It will be further understood by those skilled in the art that the foregoing description is of the preferred embodiments of the present invention and that various changes and modifications may be made to the invention without departing from the spirit and scope thereof.

1. A content addressable memory device comprising a CAM core having a plurality of words, each word includes a data field for storing target data and a weight field for storing weight data for use in weighting the target data stored in the data field,
wherein, both the data field and the weight field are simultaneously searched for matching between search key data and the target data stored in the data field and for matching between weight search data used for searching for the weight data and the weight data stored in the weight field, and a search result is output from among the words storing the target data that is matched with the search key data in accordance with the weight of the target data.

2. A content addressable memory device according to claim 1, wherein the weight of the target data is binary encoded in the weight data.

3. A content addressable memory device according to claim 2, wherein the weight search data is automatically generated in the content addressable memory device.

4. A content addressable memory device according to claim 3, wherein the weight search data is generated in descending order from the most significant bit and the generated upper bits are sequentially determined in accordance with the search result that is obtained by masking bits lower than the generated upper bits.

5. A content addressable memory device according to claim 3, wherein the weight search data is generated in ascending order from the least significant bit and the generated lower bits are sequentially determined in accordance with the search result that is obtained by masking bits upper than the generated lower bits.

6. A content addressable memory device according to claim 3, wherein each word in the CAM core is formed of a ternary cell.

7. A content addressable memory device according to claim 3, wherein the data field of each word in the CAM core is formed of a ternary cell and the weight field of each word in the CAM core is formed of a binary cell.

8. A content addressable memory device comprising:
a CAM core having a plurality of words, each word including a data field for storing target data and a weight field for storing weight data for use in weighting the target data stored in the data field; and
a weight search controller for controlling the CAM core such that the CAM core repeats the search by the number of times corresponding to the bit width of the weight field to generate the weight search data having the same value as the most heavy weight data or the least heavy weight data.

9. A content addressable memory device according to claim 8, further comprising:
a weight key data/mask data generator for generating weight key data and mask data indicating whether a corresponding bit in the weight key data is masked or not for each bit.
wherein the weight key data/mask data generator generates weight key data such that, in the first search, all the bits in weight key data has the same value, and as the result of the i-th (1≦i≦a number corresponding the bit width of the weight field) search, the value of the i-th bit in the next search is kept if a hit is detected and the value of the i-th bit is inverted if a hit is not detected. The weight key data/mask data generator generates mask data such that, in the i-th search, the mask data indicates that i bits from the most significant bit in the weight key data are not masked and the remaining bits are masked. And the CAM core are searched by using the search key data and the weight search data which is generated by the weight key data and the mask data.

10. A content addressable memory device according to claim 9, further comprising:
a register for setting the bit width of the weight field, and that the bit width of the weight field be varied in accordance with the bit width set by the register.

11. A content addressable memory device according to claim 8, wherein each word in the CAM core is formed of a ternary cell.

12. A content addressable memory device according to claim 8, wherein the data field of each word in the CAM core is formed of a ternary cell and the weight field of each word in the CAM core is formed of a binary cell.

13. A content addressable memory device according to claim 9, wherein each word in the CAM core is formed of a ternary cell.

14. A content addressable memory device according to claim 9, wherein the data field of each word in the CAM core is formed of a ternary cell and the weight field of each word in the CAM core is formed of a binary cell.

15. A content addressable memory device according to claim 9, further comprising:
a cascade signal input circuit and a cascade signal output circuit used for control when a plurality of CAM devices is cascaded to each other for usage,
wherein, when the plurality of devices is cascaded for usage, the cascade signal output circuit outputs cascade signals to all the upper-level and lower-level CAM devices, cascade signals output from all the upper-level and lower-level CAM devices are supplied to the cascade signal input circuit, and the cascade signals output from the cascade signal input circuit are supplied to the weight search controller, and
wherein the weight search controller controls the CAM core such that the CAM core outputs a search result in accordance with the weight of the target data if a plurality of CAM devices produces a hit signal.

16. A content addressable memory device according to claim 15, wherein each of the cascade signals is a hit signal indicating whether a matched word exists in the search result.
